(19) United States
(12) Patent Application Publication
(10) Pub. No.: US 2014/0197702 A1
(43) Pub. Date: Jul. 17, 2014

(54) ELECTRIC MOTOR ROTOR THERMAL INTERFACE WITH AXIAL HEAT SINKS

(71) Applicant: REMY TECHNOLOGIES, LLC, Pendleton, IN (US)

(72) Inventor: Bradley D. Chamberlin, Pendleton, IN (US)

(73) Assignee: REMY TECHNOLOGIES, LLC, Pendleton, IN (US)

(21) Appl. No.: 13/744,167

(22) Filed: Jan. 17, 2013

(51) Int. Cl. H02K 9/22

(52) U.S. Cl. CPC H02K 9/22
USPC 310/52

(57) ABSTRACT

A cooling system of an electric machine first and second heat sinks respectively mounted to axial ends of a rotor core, and a thermal interfacial material interposed between respective complementary surfaces of the heat sinks and the rotor core for substantially eliminating air gaps therebetween. A method of cooling includes placing thermal interfacial material onto a heat transfer interface between the rotor core and the heat sink, whereby the thermal interfacial material reduces contact resistance at the heat transfer interface. A method of cooling includes coating an axially outer surface of the rotor core and/or an axially inner surface of an annular heat sink with thermal interfacial material, and attaching the heat sink to the rotor, whereby thermal interfacial material is interposed between the inner surface of the heat sink and the outer surface of the rotor core.

### CROSS-REFERENCE

This application is filed on the same day as co-pending U.S. patent application Ser. No. ______, entitled “ELECTRIC MOTOR STATOR HOUSING INTERFERENCE GAP REDUCING METHOD AND APPARATUS,” and Ser. No. ______, entitled “ELECTRIC MOTOR ROTOR THERMAL INTERFACE FOR HUB/SHAFT.” The subject matter of these two applications is incorporated herein in entirety.

### BACKGROUND

The present invention is directed to improving the performance and thermal efficiency of electric machines and, more particularly, to methods and apparatus for improving the heat transfer process.

An electric machine is generally structured for operation as a motor and/or a generator, and may have electrical windings and/or permanent magnets, for example in a rotor and/or in a stator. Heat is produced in the windings and magnets, and by bearings or other sources of friction. Eddy currents and core losses occur within a rotor of an electric machine. Such losses result in undesirable heat within the rotor assembly. In a densely packed electric machine operating at a high performance level, excessive heat may be generated. Such heat must be removed to prevent it from reaching impermissible levels that may cause damage and/or reduction in performance or life of the motor.

Various apparatus and methods are known for removing heat. One exemplary method includes providing the electric machine with a water jacket having fluid passages through which a cooling liquid, such as water, may be circulated to remove heat. Another exemplary method may include providing an air flow, which may be assisted with a fan, through or across the electric machine to promote cooling. A further exemplary method may include spraying or otherwise directing oil or other coolant directly onto end turns of a stator winding.

There is generally an ongoing need for increasing performance and efficiency of electric machines, such by providing more power in a smaller space. Although various structures and methods have been employed for cooling an electric machine, improvement remains desirable.

### SUMMARY

It is therefore desirable to obviate the above-mentioned disadvantages by providing methods and apparatus for minimizing thermal resistance and increasing thermal efficiency.

According to an exemplary embodiment, a cooling system of an electric machine includes a rotor core, first and second heat sinks respectively mounted to axial ends of the rotor core, and a thermal interfacial material interposed between respective complementary surfaces of the heat sinks and the rotor core for substantially eliminating air gaps therebetween.

According to another exemplary embodiment, A method of cooling an electric machine having a heat sink and a rotor core includes placing a thermal interfacial material onto a heat transfer interface between the rotor core and the heat sink, whereby the thermal interfacial material reduces contact resistance at the heat transfer interface.

According to a further exemplary embodiment, a method of cooling a rotor of an electric machine includes coating at least one of an axially outer surface of the rotor core and an axially inner surface of an annular heat sink with a thermal interfacial material, and attaching the heat sink to the rotor, whereby the thermal interfacial material is interposed between the inner surface of the heat sink and the outer surface of the rotor core.

The foregoing summary does not limit the invention, which is defined by the attached claims. Similarly, neither the Title nor the Abstract is to be taken as limiting in any way the scope of the claimed invention.

### BRIEF DESCRIPTION OF THE DRAWING FIGURES

The above-mentioned aspects of exemplary embodiments will become more apparent and will be better understood by reference to the following description of the embodiments taken in conjunction with the accompanying drawings, wherein

FIG. 1 is a schematic view of an electric machine;

FIGS. 2A and 2B are schematic views showing heat transfer across the interface of two abutting surfaces;

FIG. 3 is an exploded perspective view of a rotor assembly, according to an exemplary embodiment;

FIG. 4 is a cross-sectional schematic view of an exemplary rotor core having annular heat sinks secured thereto;

FIG. 5 is an exploded perspective view of a rotor assembly with improved thermal interfacing for axial heat sinks, according to an exemplary embodiment;

FIG. 6 is a perspective view of rotor assembly after thermal interfacial material has been applied and the various components have been assembled, according to an exemplary embodiment;

FIG. 7 is a schematic cross-sectional top view of a portion of rotor assembly, according to an exemplary embodiment;

FIG. 8 is a schematic sectional view of a portion of an electric machine, according to an exemplary embodiment;

FIG. 9 is a perspective bottom view of a heat sink, according to an exemplary embodiment;

FIGS. 10A and 10B are cross-sectional views of respective fans, according to exemplary embodiments;

FIG. 11 is a partial schematic view of an exemplary bottom surface of a fan; and

FIG. 12 is a perspective view of an exemplary retaining ring.

Corresponding reference characters indicate corresponding or similar parts throughout the several views.

### DETAILED DESCRIPTION

The embodiments described below are not intended to be exhaustive or to limit the invention to the precise forms disclosed. Rather, the embodiments are chosen and described so that others skilled in the art may appreciate and understand the principles and practices of these teachings.

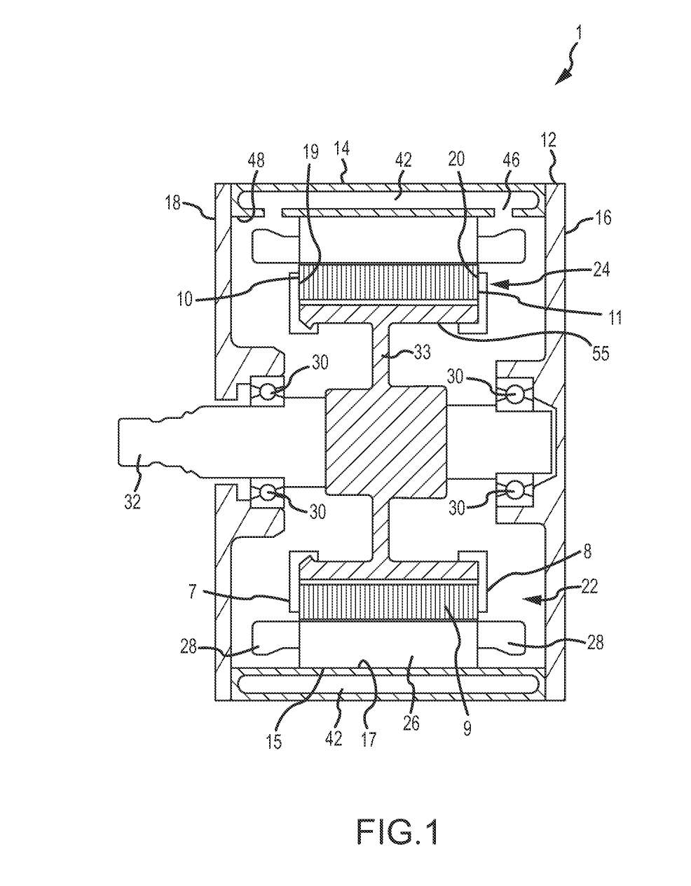

FIG. 1 is a schematic cross-sectional view of an exemplary electric machine assembly 1. Electric machine assembly 1 may include a housing 12 that has a body 14, a first end cap 16, and a second end cap 18. Electric machine 1 includes a rotor assembly 24, a stator assembly 26 including stator end turns 28, bearings 30, and an output shaft 32 secured as part of rotor 24. Rotor 24 rotates within stator 26. Rotor assembly 24 is secured to shaft 32 by a rotor hub 33. In alternative embodiments, electric machine 1 may have a “hub-less” design. Annular heat sinks 7, 8 are respectively secured to opposite axial ends of a lamination stack 9 so that the axial end surfaces 10, 11 of lamination stack 9 are contiguous with the respective axially inward surfaces 19, 20 of annular heat sinks 7, 8.

In some embodiments, module housing 12 may include at least one coolant jacket 42, for example including passages within housing body 14 and stator 26. In various embodiments, coolant jacket 42 substantially circumscribes portions of stator assembly 26, including stator end turns 28. A suitable coolant may include transmission fluid, ethylene glycol, an ethylene glycol/water mixture, water, oil, motor oil, a gas, a mist, any combination thereof, or another substance. A cooling system may include nozzles (not shown) or the like for directing a coolant onto end turns 28. The outside surface 15 of stator 26 may be formed to snugly fit in abutment with the radially inner surface 17 of cooling jacket 42 or other housing surface, such as an interior surface of a housing formed without a cooling jacket. Housing 12 may include a plurality of coolant jacket apertures 46 so that coolant jacket 42 is in fluid communication with machine cavity 22. Coolant apertures 46 may be positioned substantially adjacent to stator end turns 28 for the directing of coolant to directly contact and thereby cool end turns 28. For example, coolant jacket apertures 46 may be positioned through portions of an inner wall 48 of body 14. After exiting coolant jacket apertures 46, the coolant flows through portions of machine cavity 22 for cooling other components. In particular, coolant may be directed or sprayed onto hub 33 for cooling of rotor assembly 24. The coolant may be pressurized when it enters the housing 12. After leaving housing 12, the coolant may flow toward a heat transfer element (not shown) outside of the housing 12, for removing the heat energy received by the coolant. The heat transfer element can be a radiator or a similar heat exchanger device capable of removing heat energy.

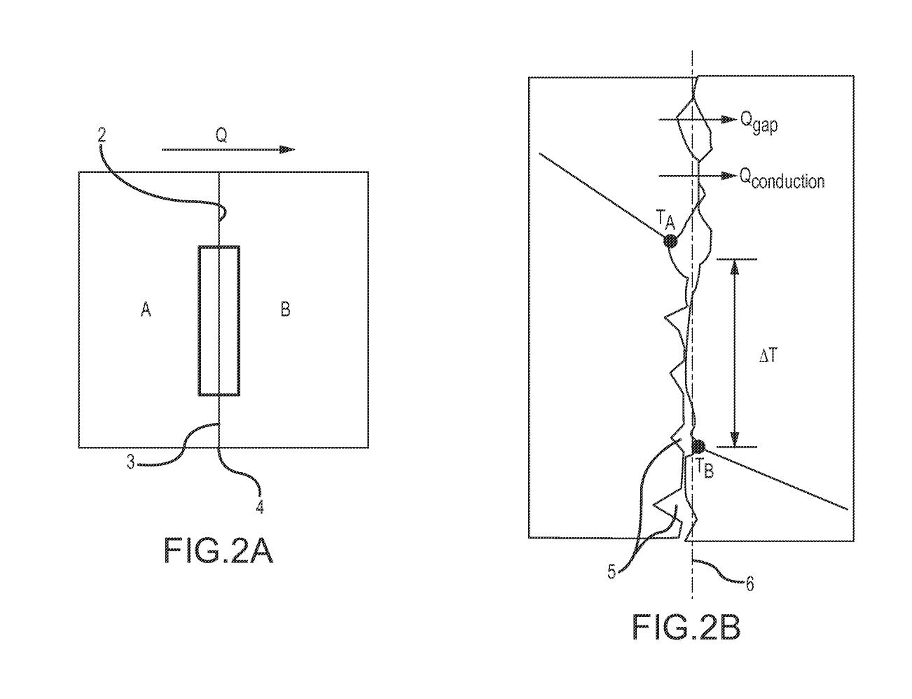

FIG. 2A is a schematic view of two contacting surfaces and FIG. 2B is a schematic view of a portion thereof. When respective complementary mating surfaces 2, 3 of two objects, A and B, are brought into abutment, a quantity of heat Q is transferred by conduction across a heat transfer interface 4. Due to machining limitations, no two solid surfaces ever form a perfect contact when they are pressed together. By comparison with an ideal mating interface, shown in FIG. 2B as a straight line 6, the actual surfaces only approximate being planar and smooth. Tiny air gaps 5 always exist between the two contacting surfaces 2, 3 due to their roughness. Such air gaps 5 create thermal resistance, also referred to as contact resistance, which can create a significant temperature difference between two mating surfaces. In the illustrated example, when heat transfer interface 4 is rough, a temperature T_{A} of object A and a temperature T_{B} of object B do not easily equalize because heat transfer Q_{GAP} across air gaps 5 is limited compared with heat transfer Q_{CONDUCTION} through contiguous surfaces. As a result of the air gaps, a temperature difference ΔT is maintained along portions of heat transfer interface 4 that are missing conduction paths. This same principle applies, for example, to the contiguous interfaces between the outer surfaces 10, 11 of lamination stack 9 and the axially inward surfaces 19, 20 of heat sinks 7, 8 (FIG. 1). This contact resistance reduces the thermal efficiency of heat transfer from rotor core surfaces 10, 11 into heat sinks 7, 8.

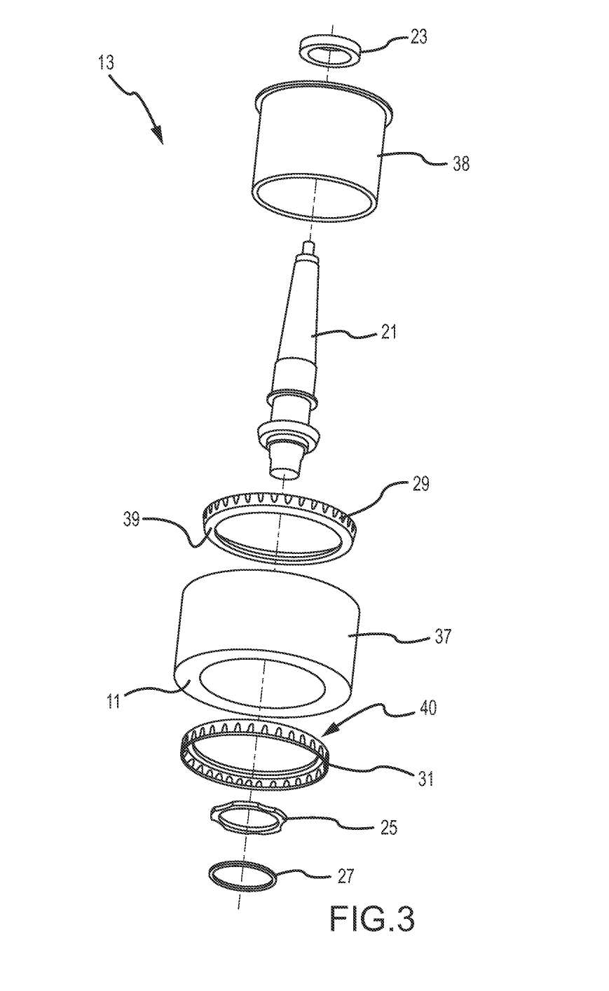

FIG. 3 is an exploded perspective view of a rotor assembly 13, according to an exemplary embodiment. A rotor core 37 is formed by stacking individual steel laminations, each coated with an electrical insulation material. The inside diameter of rotor core 37 has an interference fit with the outside diameter of a hub 38. In addition, rotor core 37 and hub 38 typically have a keyed engagement structure to prevent relative circumferential movement and thereby maintain alignment of components. Hub 38 may be secured to shaft 21 by interference fit, keyed structure, set screw, and/or by axial end fastener(s) such as nuts (not shown). Rotor assembly 13 typically also includes one or more bearing assemblies 23, wave washer(s) 25, and spacer(s) 27. A first annular heat sink 29 and a second annular heat sink 31 are respectively secured to opposite axial ends of hub 38. For example, the inside diameter of hub 38 may have a radial press fit against the respective outside diameter(s) of heat sinks 29, 31. The radial press fitting of heat sinks 29, 31 is typically performed so that the respective axially inward surfaces 39, 40 of heat sinks 29, 31 are in abutment with axial ends 10, 11 (FIG. 1) of rotor core 37, for example a lamination stack 9.

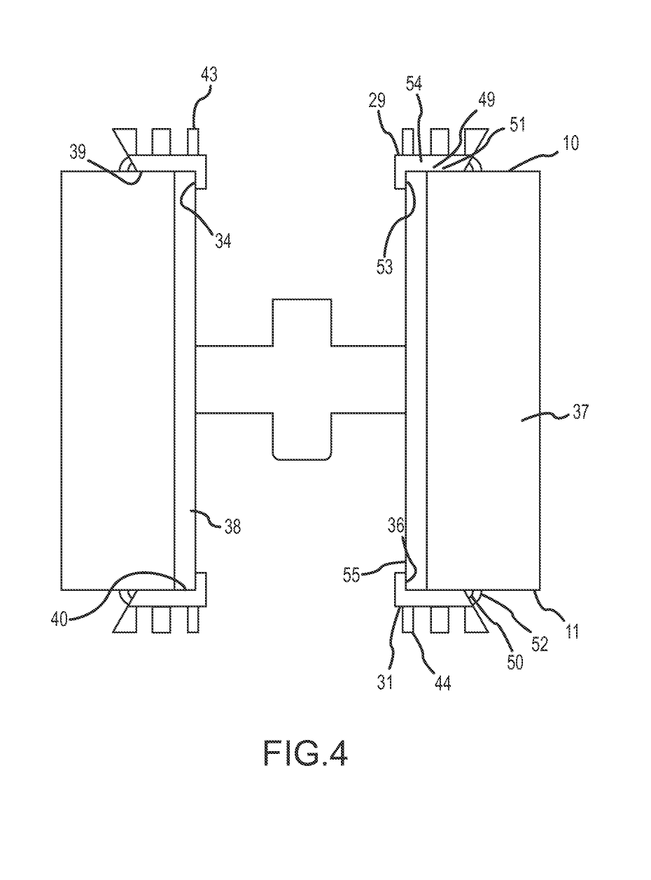

FIG. 4 is a cross-sectional schematic view of an exemplary rotor core 37 having annular heat sinks 29, 31 secured thereto. A radially outer surface 34 of heat sink 29 is press fit into engagement with the radially inward surface 55 of hub 38. A radially outer surface 36 of heat sink 31 is press fit into engagement with radially inward surface 55 of hub 38. The axially inward surface 39 of heat sink 29 is thereby held against axial end 10 and axially inward surface 40 of heat sink 31 is held against axial end 11 of rotor core 37. The respective interfaces between heat sink surfaces 39, 40 and rotor core axial ends 10, 11 have high thermal resistances due to surface irregularities and roughness that create air gaps and due to other factors such as a missing or incomplete engagement between heat sinks 29, 31 and rotor core 37. It is possible to weld the interfaces, but such welding may also maintain or create air gaps, and welding is impractical because it causes, inter alia, electrical shorting, assembly problems, additional manufacturing time and cost, and alignment and balancing issues. For example, heat sinks 29, 31 may act as balancing rings, where individual ones of respective fins 43, 44 may be bent slightly to correct rotor imbalance. In particular, heat sink fins 43, 44 may be evenly spaced around the outer circumference of respective heat sinks 29, 31, and individual fins 43, 44 may be bent radially inwardly or outwardly to precisely adjust rotational balance. Typically, automated balancing equipment is adapted to mark individual locations that require bending of fins. Alternatively, such automated balancing equipment may perform the bending, or it may deposit or remove material to/from specific locations on heat sinks 29, 31. If the rotor assembly is not balanced, centripetal force generated by the spinning assembly will amplify any imbalance and cause unwanted vibration.

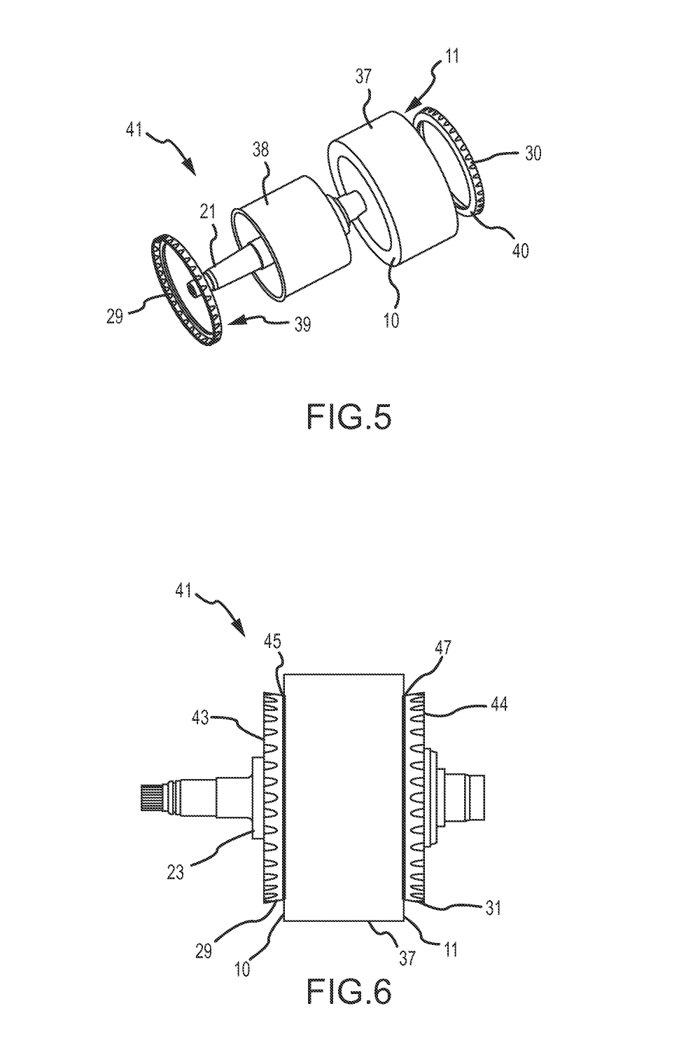

FIG. 5 is an exploded perspective view of a rotor assembly 41 with improved thermal interfacing for axial heat sinks, according to an exemplary embodiment. Hub 38 is secured to shaft 21 and to rotor core 37, as described hereinabove. In an exemplary manufacture, hub 38, shaft 21, and rotor core 37 are heated to approximately 235° F. A thermal interfacial material (TIM) having a high thermal conductivity and having a coefficient of thermal expansion (CTE) approximating that of rotor surfaces 10, 11 and heat sinks 29, 31 is applied to surfaces 34, 36, 39, 40 of respective heat sinks 29, 31. For example, the TIM may be a liquid having a paste-like consistency, a thermal conductivity of 1 to 20 W/m·K, a thickness of 0.002 to 1.5 mm, and a maximum temperature rating of 200° to over 350° C. The TIM may be used without a hardener and associated curing, or a hardener may be mixed with the TIM before applying it to surfaces 34, 36, 39, 40. The viscosity of the TIM may be adjusted to optimize flow and removal of air during assembly. After being coated with TIM, heat sinks 29, 31 are press fit into opposite axial ends of hub 38 so that the TIM integrates heat sinks 29, 31 with axial ends of rotor core 37. Subsequent processing may include cooling rotor assembly 41 to strengthen the radial press fit, removing excess TIM that has been squeezed out of the interfaces, at least partially curing the TIM, applying sealant as described below, balancing, and other processing.

FIG. 6 is a perspective view of rotor assembly 41 after TIM has been applied and the various components have been assembled. An axial end thermal interface 45 is formed by the abutment of heat sink annular surface 39 (FIGS. 4-5) and rotor core axial end surface 10. A thin layer of TIM fills air gaps created by surface irregularities, so that substantially all air is removed from interface 45 by being replaced with TIM. An axial end thermal interface 47 is likewise formed by the abutment of heat sink annular surface 40 (FIGS. 4-5) and rotor core axial end surface 11, and by the application of TIM between such surfaces. In interfaces 45, 47, the application of TIM greatly reduces thermal resistance and thereby improves thermal transfer between rotor core 37 and heat sinks 29, 31. When rotor core 37 is a lamination stack 9 (FIG. 1), a TIM having a lower viscosity may also be applied between individual laminations. For example, low viscosity TIM may be injected by capillary action. In an exemplary embodiment, a low viscosity TIM that is not electrically conductive is wicked into intra-lamination spaces when rotor core 37 is bathed in the TIM prior to assembly; a higher viscosity TIM, for example having a consistency of paste, is then applied to surfaces 10, 11 of rotor core 37 prior to the abutment of respective surfaces 39, 40 of heat sinks 29, 31. As a result, air gaps within rotor core 37 and air gaps at interfaces 45, 47 are removed. By reducing the thermal resistance within rotor core 37 and at thermal interfaces 45, 47, additional heat can be dissipated from a rotor assembly, and electric machine 1 can operate at a cooler temperature.

After assembly, the annular, radially outer periphery of thermal interface 45 typically has an annular bead 49 of TIM at the interface of surfaces 10, 39, and the annular, radially outer periphery of thermal interface 47 has an annular bead 50 of TIM at the interface of surfaces 11, 40, as shown in FIG. 4. The annular beads result from excess TIM being pushed out of the interfaces by the assembly process. Sealing the TIM at the circumferential periphery of each interface 45, 47 may be necessary in applications where the TIM remains in a liquid state and is not cured. Such sealing may prevent migration of air and other contaminants into the TIM spaces, and may prevent displacement of the TIM. Structure of rotor core 37 and/or heat sinks 29, 31 may also be adapted to seal TIM within interfaces 45, 47. When annular beads 49, 50 are fully cured, additional processing may be avoided. However, when the TIM does not fully cure, or when reliability may be affected by centrifugal forces pushing the TIM radially outward over time, any excess TIM in beads 49, 50 is removed and a curable epoxy or the like may then be applied as annular beads 51, 52 for sealing the TIM inside thermal interfaces 45, 47.

Sealing TIM within interfaces 45, 47 may create vacuums therein, whereby migration of TIM or air is prevented. Annular sealing members 51, 52 may be required when migration of TIM is foreseen, for example when the viscosity of the TIM is low and/or when TIM at a radially outer edge may be subjected to contaminants. In some applications, such sealing may be effected by use of a temporary gasket that is only required during the manufacturing process. Seals 51, 52 may alternatively include O-rings, gaskets, resin, fiber, and/or structural barriers that block any exit paths out of thermal interfaces 45, 47.

Some TIM may be partially or fully cured by being mixed with a hardener. Typically such curing takes approximately two hours at room temperature and approximately five minutes at an elevated temperature such as 100° C. Alternatively, TIM may remain in a liquid state when annular sealing members 51, 52 seal interfaces 45, 47 with separate materials such as beads of epoxy. Further, when TIM is squeezed to form TIM beads 49, 50, this exposed TIM may harden and effect a seal. In some applications, TIM maintains a consistency of grease and does not cure. For example, air gaps 5 that exist as a part of imperfections of surfaces 10, 11, 39, 40 may be isolated, and TIM displacing the air of such spaces is also isolated. In such a case, curing and an associated use of hardeners may thereby be unnecessary and/or undesirable. When TIM has a high viscosity and no migration, the absence of thermal epoxies or other hardeners may reduce shrinkage and similar reliability issues. Depending on a particular application, TIM may contain silicone, alumina or other metal oxides, binding agents, epoxy, and/or other material. The TIM has a high thermal conductivity and a high thermal stability, and may be formulated to have minimal evaporation, hardening, melting, separation, migration, or loss of adhesion. Suitable materials are available from TIMTRONICS. However, due to the small size and space of air gaps 5, the size and shapes of fillers and other ingredients of the TIM, such as alumina, is typically kept below 0.03 mm.

The rate of assembly is typically as slow as is practical. For example, when heat sinks 29, 31 are being inserted, a slow insertion movement helps distribute TIM into air gaps 5. The high conformability of TIM assures that nearly all air is removed. A longer cure time assures that TIM spreads and becomes uniformly distributed. For example, a nominal TIM thickness may be 0.03 mm. By slowly lowering TIM-coated stator heat sinks 29, 31 in an axial direction into the inner diameter of a heated rotor core 37 and/or hub 38, the interference fitting process removes air gaps 5 by slowly squeezing TIM. Once air gaps 5 have been filled, TIM does not readily migrate because air gaps 5 are not continuous. In other words, a tight fitment at interfaces 45, 47 and the lack of channels for TIM migration prevent TIM from being displaced prior to curing. In manufacturing, TIM is metered to assure that a precise volume is being applied, whereby residue is minimized and TIM interfaces 45, 47 become uniformly filled. In an alternative manufacture, TIM may be placed onto axial surfaces 10, 11 of rotor core 37 prior to assembly, or all surfaces 10, 11, 39, 40 may be coated prior to assembly. To assure that all air gaps 5 are filled, rubber blade(s) (not shown) or the like may be used for spreading TIM onto a given surface in any number of passes, prior to assembly. Since it may be desirable for TIM to have adherence properties that resist flow, the coating of surface(s) 10, 11, 39, 40 is typically performed by forcing TIM against such surface(s).

Rotor assembly 41 may be contained in a housing 12 (FIG. 1) having a cavity 22 that contains a volume of air and a circulating coolant such as oil. The rotation of rotor assembly 41 causes the respective annular arrays of fins 43, 44 to create interruption zones in the coolant flow by their circumferential movement. The rotation of fins 43, 44 also stirs and agitates the air within cavity 22. The movements of coolant and air act to dissipate heat caused by transient conditions.

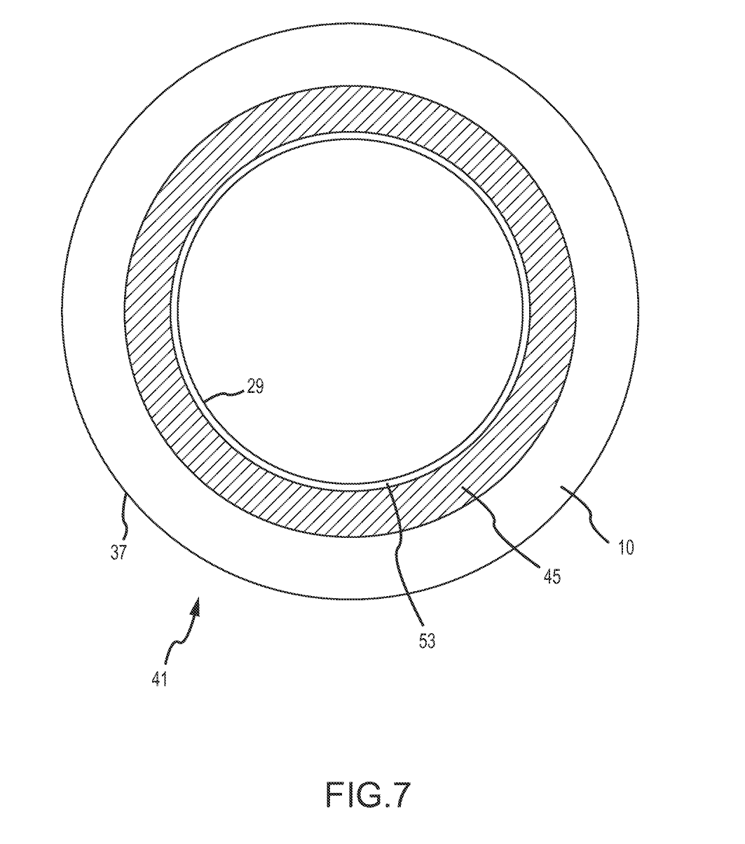

Testing of exemplary embodiments has shown significant advantages and improvements for heat transfer by placement of TIM at thermal interfaces. FIG. 7 is a schematic cross-sectional top view of a portion of rotor assembly 41. Heat sink 29 has an axially-extending annular fitting portion 53 (see also FIG. 4) that is biased against the inner diameter of hub 38. A radially inner portion of axial end surface 10 is covered by the radially-extending portion 54 of heat sink 29. This covered area of surface 10 under heat sink portion 54 defines thermal interface 45. Although exemplary embodiments are described for an annular heat transfer interface 45, portion 54 of heat sink 29 may have any appropriate shape. For example, axial end surface 10 may be formed with channels, gaps, slots, protrusions, and other deviations from a relatively smooth face, and heat sink 29 may have corresponding complementary surfaces, such as for staking, alignment, mating, containing TIM, and for other purposes. Typically, thermal interface surfaces are formed without irregularities prior to placing TIM into such heat transfer interface. Similarly, any continuous grooves, notches, or protrusions along either mating surface may be removed prior to assembly, so that TIM migration is substantially prevented by elimination of potential migration channels. In other words, by eliminating exit passageways, the TIM cannot migrate. Although exemplary embodiments have been described for configurations with a rotor inside of a stator, the embodiments may also be adapted for configurations having a rotor radially outward of a stator.

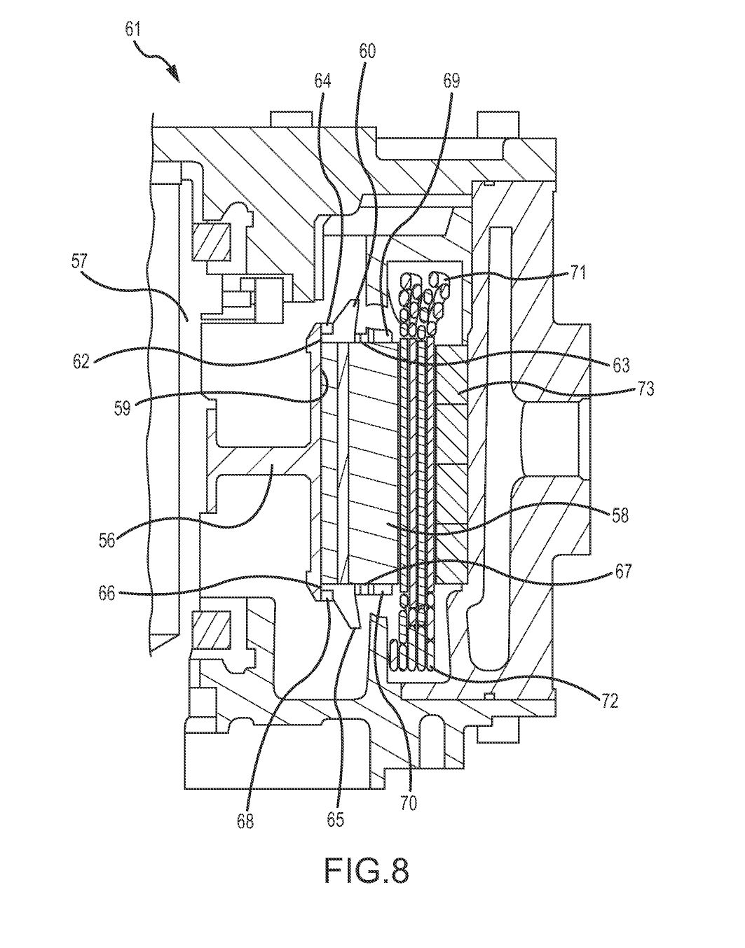

FIG. 8 is a schematic sectional view of a portion of an electric machine 61, according to an exemplary embodiment. A hub 56 is secured to a shaft 57 at a radially inner portion and is secured to a rotor core 58 at a radially outer surface 59. A first axial fan 60 has an annular, radially inner surface 62 that is press fit onto annular hub surface 59. TIM is placed at the axial end interface 63 between fan 60 and rotor core 58. An annular ring 64 may optionally be press fit or otherwise secured to hub surface 59 for preventing axial movement of fan 60, sealing interface 63, for balancing, and/or for other reasons. For example, ring 64 may include a bead of epoxy. A second axial fan 65 has an annular, radially inner surface 66 that is press fit onto annular hub surface 59. TIM is placed at the axial end interface 67 between fan 60 and rotor core 58. An annular ring 68 may optionally be secured to the axial end of hub surface 59 to abut an axial end of fan 65. In operation, the rotation of hub 56 causes fan blades 69, 70 to circulate air and/or other fluid for cooling end turns 71, 72 of stator 73.

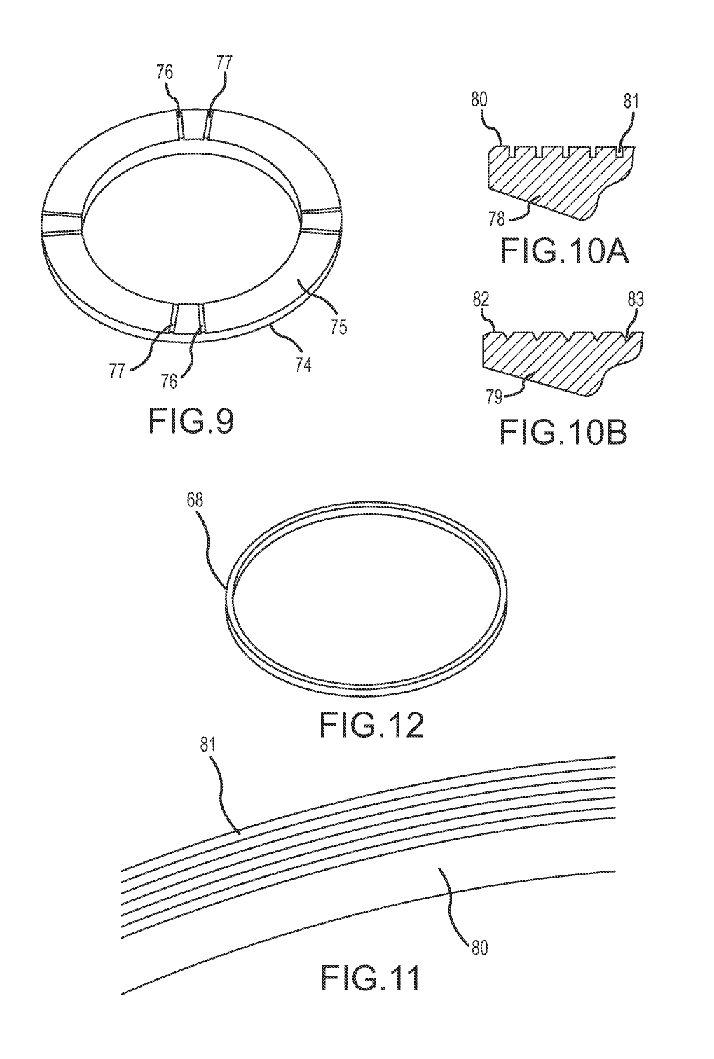

FIG. 9 is a perspective bottom view of a heat sink 74, according to an exemplary alternative embodiment. Axially inward surface 75 may have any number of radially extending barriers 76, 77 that may respectively be protrusions or grooves. When TIM is placed at the axial end interface 67 between fan 60 and rotor core 58 (e.g., FIG. 8), barriers may reduce shifting of TIM during operation. FIGS. 10A and 10B are sectional views of respective fans 78, 79. The interfacing (bottom) surface 80 of fan 78 contains annular grooves 81 having a rectangular shape. The interfacing (bottom) surface 82 of fan 79 contains annular grooves 83 formed with a triangular shape. For example, grooves 81, 83 become filled with TIM during assembly and act to contain TIM as a floating thermal interface. Barriers 76, 77 of FIG. 9 act to reduce circumferential TIM migration, and grooves 81, 83 of FIGS. 10A-B act to prevent TIM migration in the radial direction. FIG. 11 is a partial schematic view of an exemplary bottom surface 80 of fan 78. FIG. 12 is a perspective view of an exemplary retaining ring 68 (e.g., FIG. 8). In various embodiments, when TIM remains in a semi-solid state as a result of its inability to fully cure, it may become necessary to retain such TIM in an enclosure or within barriers. For example, when TIM is homogenous and contains particles having a size greater than any exit path, the TIM is thereby retained. Grooves, protrusions, or other structure such as epoxy may be utilized to provide barriers to TIM migration and may have any appropriate size and shape. For example, a floating TIM layer may be formed in a spiral shape that resists imbalance.

In an alternative embodiment, a hubless electric machine may have one or more heat sinks attached directly to a rotor core. The embodiments described herein may be combined, when appropriate, with aspects of the co-pending applications entitled “ELECTRIC MOTOR STATOR HOUSING INTERFERENCE GAP REDUCING METHOD AND APPARATUS” and “ELECTRIC MOTOR ROTOR THERMAL INTERFACE FOR HUB/SHAFT.”

While various embodiments incorporating the present invention have been described in detail, further modifications and adaptations of the invention may occur to those skilled in the art. However, it is to be expressly understood that such modifications and adaptations are within the spirit and scope of the present invention.

1. A cooling system of an electric machine, comprising:
a rotor core;
first and second heat sinks respectively mounted to axial ends of the rotor core; and
a thermal interfacial material interposed between respective complementary surfaces of the heat sinks and the rotor core for substantially eliminating air gaps therebetween.

2. The cooling system of claim 1, wherein the heat sinks each include an annular mounting portion and fins extending axially outward from the mounting portion.

3. The cooling system of claim 1, further comprising an annular perimeter seal around the thermal interfacial material at each axial end for enclosing the material between the complementary surfaces.

4. The cooling system of claim 3, wherein the seals include epoxy.

5. The cooling system of claim 3, wherein the enclosed thermal interfacial material remains in a liquid state.

6. The cooling system of claim 1, further comprising a hub, wherein the heat sinks have an interference fit with the hub.

7. The cooling system of claim 6, wherein the interference fit includes respective outside diameter surfaces of the heat sinks and an inside diameter surface of the hub.

8. The cooling system of claim 1, wherein the thermal interfacial material is substantially uncurable thermal grease.

9. The cooling system of claim 1, wherein the thermal interfacial material has a nominal thickness between 0.002 mm and 0.5 mm.

10. A method of cooling an electric machine having a heat sink and a rotor core, comprising placing a thermal interfacial material onto a heat transfer interface between the rotor core and the heat sink, whereby the thermal interfacial material reduces contact resistance at the heat transfer interface.

11. The method of claim 10, wherein the electric machine further comprises a hub, the method further comprising:
heating and thereby expanding the hub;
installing an annular heat sink within the hub; and
cooling the hub so that the heat sink is interference fit therein.

12. The method of claim 10, wherein the heat sink comprises a plurality of fins extending axially away from the heat transfer interface, and wherein the method further comprises balancing the electric machine by bending at least one fin.

13. The method of claim 10, further comprising balancing the electric machine by at least one of depositing and removing material from the heat sink.

14. A method of cooling a rotor of an electric machine, comprising:
coating at least one of an axially outer surface of a rotor core and an axially inner surface of an annular heat sink with a thermal interfacial material; and
attaching the heat sink to the rotor;
whereby the thermal interfacial material is interposed between the inner surface of the heat sink and the outer surface of the rotor core.

15. The method of claim 14, further comprising sealing the heat sink to the rotor, thereby enclosing at least one radial end of the thermal interfacial material.

16. The method of claim 15, wherein the sealing comprises curing the thermal interfacial material.

17. The method of claim 15, wherein the sealing comprises applying a bead of epoxy.

18. The method of claim 14, wherein the coating includes biasing the thermal interfacial material against the surface being coated.

19. The method of claim 14, further comprising balancing the rotor by at least one of depositing and removing material from the heat sink.

20. The method of claim 15, wherein the heat sink comprises a plurality of fins extending axially away from the thermal interfacial material, and wherein the method further comprises balancing the electric machine by bending at least one fin.
